(19) United States
(12) Patent Application Publication
(10) Pub. No.: US 2016/0207777 A1
(43) Pub. Date: Jul. 21, 2016

(54) CHEMICAL ACTIVATION OF CARBON WITH AT LEAST ONE ADDITIVE

(71) Applicant: CORNING INCORPORATED, Corning, NY (US)

(72) Inventors: James Gerard Fagan, Painted Post, NY (US); Kishor Purushottam Gadkaree, Painted Post, NY (US); Atul Kumar, Horseheads, NY (US); Samuel Odei Owusu, Horseheads, NY (US); Kamjula Pattabhirami Reddy, Corning, NY (US)

(21) Appl. No.: 14/908,680

(22) PCT Filed: Jul. 23, 2014
(86) PCT No.: PCT/US2014/047728

§ 371 Date: Jan. 29, 2016

Related U.S. Application Data
(60) Provisional application No. 61/860,489, filed on Jul. 31, 2013.

(51) Int. Cl. C01B 31/12; H01G 11/34

(52) U.S. Cl. CPC C01B 31/125; H01G 11/34

(57) ABSTRACT

The disclosure relates, in various embodiments, to methods for forming activated carbon comprising (a) providing a feedstock mixture comprising a carbon feedstock, at least one activating agent chosen from alkali metal hydroxides, and at least one additive chosen from fats, oils, fatty acids, fatty acid esters, and polyhydroxylated compounds to form a feedstock mixture; (b) optionally heating the feedstock mixture to a first temperature, and when a step of heating the feedstock mixture to a first temperature is performed, optionally holding the feedstock mixture at the first temperature for a time sufficient to react the at least one activating agent with the at least one additive; (c) optionally milling and/or grinding the feedstock mixture; (d) heating the feedstock mixture to an activation temperature; and (e) holding the feedstock mixture at the activation temperature for a time sufficient to form activated carbon.

### CROSS-REFERENCE TO RELATED APPLICATIONS

This application claims the benefit of priority under 35 U.S.C. §119 of U.S. Provisional Application Ser. No. 61/860,489 filed on Jul. 31, 2013, the content of which is relied upon and incorporated herein by reference in its entirety.

### FIELD OF THE DISCLOSURE

The present disclosure relates generally to methods for forming activated carbon, and more particularly to chemical activation of carbon using at least one additive to reduce foaming and/or fluxing.

### BACKGROUND

Energy storage devices such as ultracapacitors may be used in a variety of applications, ranging from cell phones to hybrid vehicles. Ultracapacitors have emerged as an alternative to batteries in applications that require high power, long shelf life, and/or long cycle life. Ultracapacitors typically comprise a porous separator and an organic electrolyte sandwiched between a pair of carbon-based electrodes. The energy storage is achieved by separating and storing electrical charge in the electrochemical double layers that are created at the interfaces between the electrodes and the electrolyte. Important characteristics of these devices are the energy density and power density they can provide, which are both largely determined by the properties of the carbon that is incorporated into the electrodes.

Carbon-based electrodes suitable for incorporation into energy storage devices are known. Activated carbon is widely used as a porous material in ultracapacitors due to its large surface area, electronic conductivity, ionic capacitance, chemical stability, and/or low cost. Activated carbon can be made from natural precursor materials, such as coals, nut shells, and biomass, or synthetic materials such as phenolic resins. With both natural and synthetic precursors, the activated carbon can be formed by carbonizing the precursor and then activating the intermediate product. The activation can comprise physical (e.g., steam or CO₂) or chemical activation at elevated temperatures to increase the porosity and hence the surface area of the carbon. Several chemical reagents have been used in the art, including KOH, NaOH, LiOH, H₃PO₄, Na₂CO₃, KCl, NaCl, MgCl₂, AlCl₃, P₂O₅, K₂CO₃, K₂S, KCNS, and ZnCl₂; however, the use of alkali metal hydroxides, such as KOH, NaOH, and LiOH has been widely adopted to achieve various desirable properties.

Both physical and chemical activation processes typically involve large thermal budgets to heat and react the carbonized material with the activating agent. In the case of chemical activation, corrosive by-products can be formed when a carbonized material is heated and reacted with caustic chemical activating agents such as alkali metal hydroxides. Additionally, phase changes, or fluxing, may occur during the heating and reacting of the carbonized material and chemical activating agent, which can result in agglomeration of the mixture during processing. These drawbacks can add complexity and cost to the overall process, particularly for reactions that are carried out at elevated temperatures for extended periods of time.

Significant issues have been reported when caustics, such as KOH, are used for the chemical activation of carbon. For example, when rotary kilns are used in carbon activation, it is often required that the feedstock undergoes calcination and/or drying and/or dehydration prior to treatment at activation temperatures. Agglomeration tends to pose significant issues, such as increased process complexity and/or cost, in continuous processes, for instance, processes employing screw kneaders.

As a means to avoid agglomeration issues, other technologies such as roller hearths, have been employed wherein trays are loaded with activation mix material and passed through a multiple zone tunnel furnace. Such furnaces may be costly in operation and may have limited throughput since only one tray level is passed through the furnace at a time. The furnace width is also a limiting factor for roller hearths on throughput, since roller length spanning across the furnace is limited by material availability and strength at service temperature.

Additionally, chemical activation using alkali metal hydroxides results in the release of several gases (e.g., CO, CO₂, H₂, and H₂O) during processing, which leads to the formation of foam. Foaming during activation tends to limit the amount of material that can be processed in the activation reactor. For instance, in some cases, only about 10-30%, for example about 20%, of the crucible volume can be utilized for the feedstock mixture in order to account for foaming during processing. As discussed above, the corrosive nature of the feedstock mixture requires the use of reactors constructed using costly and corrosion-resistant materials. Therefore, it would be advantageous to develop a chemical activation process that allows an increased feedstock throughput.

Prior art methods to avoid foaming during processing involve the use of compacted feedstock pellets in place of granular or particulate feedstock. The pellets are made, e.g., by vacuum drying the feedstock mixture for several hours and/or by adding binders to the feedstock mixture. The pellets are then activated and processed in solid, pelletized form. However, the extra step of vacuum drying and/or the extra binder component(s) tend to increase the cost and/or length of production of the activated carbon.

Accordingly, it would be advantageous to provide activated carbon materials and processes for forming activated carbon materials using a more economical chemical activation route, while also minimizing issues relating to corrosion, agglomeration, fluxing, and/or foaming. The resulting activated carbon materials can possess a high capacitance and/or surface area to volume ratio and can be used to form carbon-based electrodes that enable efficient, long-life and high energy density devices.

### SUMMARY

The disclosure relates, in various embodiments, to methods for forming activated carbon comprising (a) providing a feedstock mixture comprising a carbon feedstock, at least one activating agent chosen from alkali metal hydroxides, and at least one additive chosen from fats, oils, fatty acids, fatty acid esters, and polyhydroxylated compounds; (b) optionally heating the feedstock mixture to a first temperature, and when a step of heating the feedstock mixture to a first temperature is performed, optionally holding the feedstock mixture at the first temperature for a time sufficient to react the at least one activating agent with the at least one additive; (c) optionally granulating the feedstock mixture; (d) heating the feedstock mixture to an activation temperature; and (e) holding the feedstock mixture at the activation temperature for a time sufficient to form activated carbon.

In certain embodiments, the weight ratio of activating agent to carbon feedstock in the feedstock mixture ranges from about 0.5:1 to about 5:1 and the weight ratio of activating agent to additive ranges from about 5:1 to about 30:1. The feedstock mixture may, in various embodiments, be a particulate mixture of the carbon feedstock, the at least one activating agent, and the at least one additive, e.g., a powder or granular mixture. In some non-limiting embodiments, the at least one chemical activating agent is chosen from KOH, NaOH, and LiOH and the at least one additive is chosen from animal fats, vegetable oils, fatty acids, fatty acid esters, polyols, cellulose ethers, and ionic and non-ionic silicone oils, and combinations thereof.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### DETAILED DESCRIPTION

Disclosed herein is a method for forming activated carbon comprising (a) providing a feedstock mixture comprising a carbon feedstock, at least one activating agent chosen from alkali metal hydroxides, and at least one additive chosen from fats, oils, fatty acids, and fatty acid esters; (b) optionally heating the feedstock mixture to a first temperature, and when a step of heating the feedstock mixture to a first temperature is performed, optionally holding the feedstock mixture at the first temperature for a time sufficient to react the at least one activating agent with the at least one additive; (c) optionally granulating the feedstock mixture; (d) heating the feedstock mixture to an activation temperature; and (e) holding the feedstock mixture at the activation temperature for a time sufficient to form activated carbon.

Also disclosed herein is a method for forming activated carbon comprising (a) providing a feedstock mixture comprising a carbon feedstock, at least one activating agent chosen from alkali metal hydroxides, and at least one additive chosen from polyols, cellulose ethers, and ionic and non-ionic silicone oils; (b) optionally milling and/or grinding the feedstock mixture; (c) heating the feedstock mixture to an activation temperature; and (d) holding the feedstock mixture at the activation temperature for a time sufficient to form activated carbon, wherein the feedstock mixture is in particulate form.

Theoretical Mechanisms of Action

Without wishing to be bound by theory, it is believed that when fats, oils, fatty acids, and/or fatty acid esters are employed as the at least one additive, these additives react with the alkali metal hydroxide in a saponification reaction, creating an alkali-containing carboxylate (soap) and various by products, such as glycerol and water. For instance, equation (a) below illustrates the reaction between a triglyceride (fat) and KOH to produce potassium carboxylate and glycerol. Equation (b) below illustrates the reaction between a fatty acid and KOH to produce potassium carboxylate and water. Equation (c) below illustrates the reaction between a fatty acid ester and KOH to produce potassium carboxylate and an alcohol.

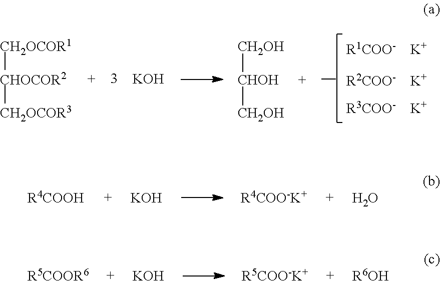

Further, without wishing to be bound by theory, it is believed that the conversion of the alkali metal hydroxide to an alkali-containing carboxylate inhibits the degree of fluxing during processing at temperatures below about 500° C. by reducing the amount of alkali metal hydroxide present in the feedstock mixture and available to undergo phase changes. Additionally, the glycerol reaction product can further mitigate foaming by lowering the surface tension of the mixture, as discussed below.

Foaming may occur during several stages of the chemical activation process. Using KOH as a non-limiting example, the following reactions may occur at various stages during activation:

KOH.xH₂O→KOH+xH₂O (1)

2KOH→K₂O+H₂O (2)

C+H₂O→CO+H₂ (3)

CO+H₂O→CO₂+H₂ (4)

CO₂+K₂O→K₂CO₃ (5)

6KOH+2C→2K+3H2+2K₂CO₃ (6)

K₂CO₃=K₂O+CO₂ (7)

CO₂+C→2CO (8)

K₂CO₃+2C→2K+3CO (9)

C+K₂O→2K+CO (10)

K+C→KCₙ (11)

The first stage of foaming may occur at a temperature ranging from about 115° C. to about 155° C., due to release of water from crystallized KOH (equation 1). The activating agent then dries up in a temperature range of from about 155° C. to about 325° C. The second stage of foaming may occur at a temperature ranging from about 325° C. to about 500° C., when KOH liquefies again and the viscosity decreases with increasing temperature. Large amounts of gas are generated in this stage due to various chemical reactions (equations 2-4), which in turn leads to the formation of foam and bubbles. The foam rises from the surface of the feedstock mixture and may rise within the reaction vessel, wicking up the walls. The third stage of foaming may occur at a temperature ranging from about 500° C. to about 750° C., where the viscosity increases with increasing temperature due to the conversion of KOH into K₂CO₃ (equations 5-6). The feedstock mixture starts to look like a wet solid as the temperature approaches about 600° C., and at about 700° C., the formed K₂CO₃ starts to decompose into K₂O and CO gas (equations 7-8). The potassium compounds (K₂O and K₂CO₃) can also be reduced by carbon to produce potassium and CO gas at temperatures exceeding 700° C. (equations 9-10). The potassium then intercalates into the carbon matrix (equation 11) and, after washing, creates micro-porosity in the carbon matrix to produce activated carbon.

The at least one additive included in the feedstock mixture may serve to hinder formation of foam during one or more of the foaming stages described above. Specifically, the additives themselves or their reaction products with the at least one activating agent may exhibit a low viscosity and low surface tension, thus being able to spread as a thin layer on the bubbles making up the foam. The bubbles are thus destabilized and ultimately rupture or collapse.

Carbon Feedstock

According to various embodiments, the carbon feedstock may comprise a carbonized material such as coal or a carbonized material derived from a carbon precursor. Example carbon precursors include natural materials such as nut shells, wood, biomass, non-lignocellulosic sources, and synthetic materials, such as phenolic resins, including poly(vinyl alcohol) and (poly)acrylonitrile. For instance, the carbon precursor can be chosen from edible grains such as wheat flour, walnut flour, corn flour, corn starch, corn meal, rice flour, and potato flour. Other non-limiting examples of carbon precursors include coconut husks, beets, millet, soybean, barley, and cotton. The carbon precursor can be derived from a crop or plant that may or may not be genetically-engineered.

Further exemplary carbon precursor materials and associated methods of forming carbon feedstock are disclosed in commonly-owned U.S. Pat. Nos. 8,198,210, 8,318,356, and 8,482,901, and U.S. Patent Application Publication No. 2010/0150814, all of which are incorporated herein by reference in their entireties.

Carbon precursor materials can be carbonized to form carbon feedstock by heating in an inert or reducing atmosphere. Example inert or reducing gases and gas mixtures include one or more of hydrogen, nitrogen, ammonia, helium and argon. In an example process, a carbon precursor can be heated at a temperature from about 500° C. to 950° C. (e.g., about 500, 550, 600, 650, 700, 750, 800, 850, 900 or 950° C., and all ranges and subranges therebetween) for a predetermined time (e.g., about 0.5, 1, 2, 4, 8 or more hours, and all ranges and subranges therebetween) and then optionally cooled. During carbonization, the carbon precursor may be reduced and decomposed to form carbon feedstock.

In various embodiments, the carbonization may be performed using a conventional furnace or by heating within a microwave reaction chamber using microwave energy. For instance, a carbon precursor can be exposed to microwave energy such that it is heated and reduced to char within a microwave reactor to form carbon feedstock that is then combined with a chemical activating agent to form a feedstock mixture. It is envisioned that a single carbon precursor material or combination of precursor materials could be used to optimize the properties of the activated carbon product.

According to certain non-limiting embodiments, the carbon feedstock may be further processed by crushing, pulverizing, grinding, and/or milling the carbon feedstock to form a carbonized powder. In such embodiments, the carbon feedstock can be a particulate feedstock, for example taking the form of a powder or granules. In at least certain non-limiting embodiments, the carbon feedstock is a carbonized powder. The carbon feedstock may, for example, have an average particle size of less than about 100 microns, for instance, less than about 100, 50, 25, 10, or 5 microns, and all ranges and subranges therebetween. In various embodiments, the carbon feedstock can have an average particle size of less than about 5 microns, such as less than about 4, 3, 2, or 1 microns, and all ranges and subranges therebetween. In further embodiments, the particle size of the carbon feedstock may range from about 0.5 to about 25 microns, such as from about 0.5 microns to about 5 microns.

Activating Agents

The at least one activating agent may, in certain embodiments, be chosen from alkali metal hydroxides, such as, for example, KOH, NaOH, LiOH, and mixtures thereof. It is also contemplated that other chemical activating agents known in the art may be used in conjunction with an alkali metal hydroxide, for instance, H₃PO₄, Na₂CO₃, KCl, NaCl, MgCl₂, AlCl₃, P₂O₅, K₂CO₃, K₂S, and KCNS, and/or ZnCl₂.

In certain embodiments, the carbon feedstock and/or the at least one additive may be combined with a solution of the at least one activating agent. For example, an aqueous solution may be used, and the concentration of chemical activating agent in the solution may range from about 10 to about 90 wt %. In such embodiments, the wet feedstock mixture can optionally be dried during and/or after mixing to provide a substantially dry feedstock mixture. In further embodiments, the carbon feedstock and/or the at least one additive can be combined with the at least one activating agent to form a dry feedstock mixture, e.g., without the use of any liquid or solvent.

The carbon feedstock and the at least one activating agent may be combined in any suitable ratio to form the feedstock mixture and to bring about chemical activation of the carbon. The specific value of a suitable ratio may depend, for example, on the physical form and type of the carbon feedstock and the activating agent and the concentration, if one or both are in the form of a mixture or solution. A ratio of activating agent to carbon feedstock on the basis of dry material weight can range, for example, from about 0.5:1 to about 5:1. For example, the weight ratio can range from about 1:1 to about 4:1, or from about 2:1 to about 3:1, including all ranges and subranges therebetween. In certain embodiments, the weight ratio of activating agent to carbon feedstock may be about 1:1, 2:1, 3:1, 4:1, or 5:1, including all ranges and subranges therebetween.

Additives

The at least one additive may, in certain embodiments, be chosen from animal fats, vegetable oils, fatty acids, fatty acid esters, polyols, cellulose ethers, ionic and non-ionic silicone oils, and mixtures thereof. As non-limiting examples of suitable fats and oils, mention may be made of tallow, fish oil, whale oil, liver oil, cod liver oil, butter, coconut oil, palm kernel oil, palm oil, nutmeg oil, olive oil, soybean oil, sesame oil, safflower oil, linseed oil, castor oil, vegetable oil, canola oil, and mixtures thereof. Exemplary fatty acids may include, for example, saturated and unsaturated fatty acids comprising from about 2 to about 30 carbon atoms, such as acetic acid, propanoic acid, butyric acid, caproic acid, caprylic acid, capric acid, lauric acid, myristic acid, palmitic acid, palmitoleic acid, stearic acid, oleic acid, linoleic acid, linoleric acid, arachidonic acid, behenic acid, and mixtures thereof. Ester derivatives of any of the above-noted fatty acids may also be used. It is noted that various oils and fats listed above may serve as the source of the fatty acids and esters listed herein. Suitable polyols may include, for example, sugar alcohols, such as sorbitol, xylitol, erythritol, malitol, and isomalt; monomeric polyols, such as glycerol, pentaerythritol, ethylene glycol, and sucrose; and polymeric polyols, such as polyether polyols and polyester polyols. It is also contemplated that cellulose ethers may be used as the at least one additive, for example, methylcellulose, hydroxymethylcellulose, carboxymethylcellulose, ethylcellulose, hydroxyethylcellulose, carboxyethylcellulose, hydroxyypropylcellulose, derivatives thereof, and mixtures thereof. Suitable commercially available cellulose ethers are sold, for instance, by the company Dow Chemical under the trade names ETHOCEL™ and METHOCEL™. Further additives include ionic and non-ionic silicone oils, which may or may not be in the form of emulsions, for example the silicone emulsions sold by Dow Corning under the trade name XIAMETER®.

In certain embodiments, the at least one additive may be in the form of a liquid or solid, e.g., powder. For example, a liquid additive may be used, resulting in a wet or substantially wet feedstock mixture, which can optionally be dried during and/or after mixing to provide a substantially dry feedstock mixture. In further embodiments, the carbon feedstock and/or the at least one activating agent can be combined with a solid additive to form a dry feedstock mixture, e.g., without the use of any liquid or solvent.

The at least one additive and the at least one activating agent may be combined in any suitable ratio to form the feedstock mixture and, in some instances, a ratio suitable for reacting the at least one additive with the at least one activating agent. The specific value of a suitable ratio may depend, for example, on the physical form and type of the additive and the activating agent and the concentration, if one or both are in the form of a mixture or solution. For instance, when fats are used as the at least one additive, it may be advantageous to employ a molar ratio of activating agent to additive of at least about 3:1, although ratios below and above 3:1 can also be used. When fatty acids and their esters are employed as the additive, it may be advantageous to employ a molar ratio of activating agent to additive of at least about 1:1, although ratios below and above 1:1 can also be used.

In other embodiments, the ratio of activating agent to additive on the basis of dry material weight can range, for example, from about 5:1 to about 30:1. For example, the weight ratio can range from about 5:1 to about 20:1 or from about 10:1 to about 15:1, including all ranges and subranges therebetween. In certain embodiments, the weight ratio of activating agent to carbon feedstock may be about 5:1, 10:1, 15:1, 20:1, 25:1, or 30:1, including all ranges and subranges therebetween. In yet further embodiments, the weight ratio of activating agent to additive is greater than about 5:1, for instance, greater than about 10:1, or greater than about 20:1.

Without wishing to be bound by theory, it is believed that, in at least certain exemplary embodiments, the at least one additive may serve to wet the carbon feedstock. For instance, the at least one additive may be introduced as a liquid and/or the at least one additive may be introduced as a solid and then heated to bring about a solid to liquid transformation. Additionally, in at least other exemplary embodiments, it is believed that the at least one additive may serve to improve the intermixing of the feedstock components. For example, the non-polar aliphatic portion of a fat or fatty acid molecule may wet the surface of a carbon feedstock particle more effectively than the polar activating agent. The polar end of the fat or fatty acid has a carboxylic nature and may be attracted to the polar and hydrated activating agent. This combined attraction may allow for more effective intermixing and wetting of the constituents and may lower the effective surface tension of the feedstock mixture as well as the degree of effective capillary action between the micron sized particles of carbon.

Methods

The feedstock mixture may be prepared by any method known that combines the carbon feedstock with the at least one chemical activating agent and the at least one additive. The various components of the feedstock mixture may be added simultaneously or in any order. For example, in certain exemplary and non-limiting embodiments, the feedstock mixture may be formed by mixing the carbon feedstock and the at least one additive, and subsequently adding the at least one activating agent. According to other exemplary and non-limiting embodiments, the carbon feedstock and the at least one activating agent are first combined and then the at least one additive is subsequently combined to form the feedstock mixture. In certain cases, for example, the feedstock mixture can be in a powder form, such as when the carbon feedstsock, additive, and activating agent are substantially dry powders. In other instances, the feedstock mixture can be in a particulate form, such as a wetted powder or slurry, for example, when a liquid activating agent and/or additive is employed.

The preparation of the feedstock mixture may occur, in at least certain exemplary and non-limiting embodiments, with or without heating. By way of non-limiting example, a pre-heating step may be employed during, before, and/or after the mixing of the feedstock mixture, in which the feedstock mixture is pre-heated to a temperature ranging from about 25° C. to about 150° C., such as from about 50° C. to about 125° C., or from about 75° C. to about 100° C., including all ranges and subranges therebetween. According to certain embodiments, the feedstock mixture may be prepared under ambient or inert conditions, e.g., in the presence of air or one or more inert gases such as nitrogen, argon, and the like.

The feedstock mixture may, in certain embodiments, be further processed by milling and/or grinding the mixture. For example, prior to mixing, the carbon feedstock, the at least one additive, and/or the at least one activating agent may be separately milled and then mixed together. In other embodiments, the feedstock mixture may be simultaneously milled during mixing. According to further embodiments, the feedstock mixture may be milled after the carbon feedstock, the at least one additive, and the at least one activating agent are mixed together. In certain embodiments, the feedstock mixture may be pulverized and/or crushed.

By way of non-limiting example, the feedstock mixture may be milled to an average particle size of less than about 100 microns, for instance, less than about 100, 50, 25, 10, or 5 microns, and all ranges and subranges therebetween. In various embodiments, the feedstock mixture can have an average particle size of less than about 5 microns, such as less than about 4, 3, 2, or 1 microns, and all ranges and subranges therebetween. In further embodiments, the average particle size of the feedstock mixture may range from about 0.5 to about 25 microns, such as from about 0.5 microns to about 5 microns.

Subsequent to mixing the feedstock mixture, with optional milling and/or pre-heating, the feedstock mixture may optionally be heated to a first temperature. The first temperature may, in certain embodiments, be any temperature suitable for reacting the at least one activating agent with the at least one additive and can vary, e.g., depending on the identities of these components. In various exemplary embodiments, the first temperature may range from about 25° C. to about 250° C., such as, for example, from about 50° C. to about 225° C., from about 75° C. to about 200° C., from about 100° C. to about 175° C., or from about 125° C. to about 150° C., including all ranges and subranges therebetween.

When a step of heating the feedstock mixture to a first temperature is performed, an additional and optional step of holding the feedstock mixture at the first temperature is also contemplated. In these embodiments, the feedstock mixture may be held at the first temperature for a time sufficient to react the at least one additive with the at least one activating agent. The residence time can vary, e.g., depending on the identities of the additive and the activating agent, the temperature, percent moisture present, and mixing method. Exemplary residence or hold times may range, for instance, from about 1 minute to about 120 minutes, such as from about 5 minutes to about 100 minutes, from about 10 minutes to about 90 minutes, from about 20 minutes to about 60 minutes, or from about 30 minutes to about 50 minutes, including all ranges and subranges therebetween. In various embodiments, the hold time may range from about 1 to about 10 minutes, for instance, when the first temperature ranges from about 120° C. to about 140° C., or the hold time may range from about 1 hour to about 2 hours, for instance, when the first temperature ranges from about 25° C. to about 75° C.

Prior to activation of the feedstock mixture, in at least certain exemplary and non-limiting embodiments, it is possible to granulate the mixture by any means known. For example, optional granulating steps may include mixing the carbon feedstock with the at least one additive and the at least one activating agent, optionally with heating, by way of roll compaction, drum pelletization, vacuum drying, freeze drying, and/or any other means suitable for mixing and pelletizing the feedstock mixture. Additionally, granulations may be accomplished using binder additives such as carbowax, a paraffin wax which may decompose with little or no residue contamination of the activated carbon. Use of such binders may also be employed in conjunction with other granulation methods including, but not limited to, roll compaction, drum pelletizing, and/or extrusion mixing and/or grating.

In certain embodiments, the feedstock mixture may be granulated while also heating the mixture. For instance, the feedstock mixture may be granulated at a temperature of less than about 500° C., such as less than about 450° C., or less than about 400° C. By way of non-limiting example, the feedstock mixture may be granulated at a temperature ranging from about 400° C. to about 500° C.

According to at least certain embodiments, the feedstock mixture may be granulated, but is not pelletized, e.g., it is in the form of a powder or small granules. For instance, the average diameter of the feedstock particles after granulation may be less than about 1 mm, such as less than about 500 microns, less than about 100 microns, or less than about 50, 25, 10, or 5 microns. In certain embodiments, when polyhydroxylated compounds such as polyols are used as the additive, the feedstock mixture is not pelletized and is instead activated in the form of a powder or small granules. In other words, in these exemplary and non-limiting embodiments, the feedstock mixture is not compacted to form pellets prior to activation.

The feedstock mixture is subsequently heated to an activation temperature sufficient to react the at least one activating agent and carbon feedstock to form activated carbon. An activating agent, for instance KOH, can interact and react with carbon such that the potassium ion is intercalated into the carbon structure and potassium carbonate is formed. The reaction kinetics for both of these processes is believed to increase at elevated temperatures, which can lead to a higher rate of activation. As used herein, the term “activation” and variations thereof refer to a process whereby the surface area of carbon is increased such as through the formation of pores within the carbon.

The activation temperature generally ranges from about 600° C. to about 900° C., such as from about 650° C. to about 850° C., or from about 700° C. to about 800° C., or from about 750° C. to about 900° C., including all ranges and subranges therebetween. The feedstock mixture is then held at the activation temperature for a time sufficient to form activated carbon. The residence or hold time may, in certain embodiments, range from about 5 minutes to about 6 hours, for instance, from about 10 minutes to about 4 hours, from about 30 minutes to about 3 hours, or from about 1 hour to about 2 hours, including all ranges and subranges therebetween. According to certain embodiments, the activation may be carried out under ambient or inert conditions, e.g., in the presence of air or one or more inert gases such as nitrogen, argon, and the like.

According to the embodiments disclosed herein, various processing alternatives are contemplated by the instant disclosure. These alternatives include, but are not limited to the following methods.

In one embodiment, a carbon feedstock is mixed with at least one additive in solid or liquid form. These materials can be mixed at a temperature ranging from room temperature up to a temperature slightly above the melting point if a fat is used as the additive (e.g., up to about 100° C.). The activating agent is then added in liquid or solid form. It may, in some embodiments, be preferable to add the activating agent in powder form to mitigate the potential for alkali carbonate formation due to reactions with carbon dioxide in the air. In other embodiments, the mixing can be done in an inert atmosphere, such as in the presence of nitrogen gas.

The resulting feedstock mixture can then be heated to a first temperature and, in certain embodiments, held for a time sufficient to react the activating agent with the additive, typically from about 25° C. to about 200° C. for about 1 minute to 2 hours. The feedstock mixture can be further heated and granulated with or without agitation, e.g., up to a temperature ranging from about 400° C. to about 500° C. The feedstock mixture is then fed into a furnace or other reaction vessel to be heated to the activation temperature. This embodiment may be suitable, for example, in the case when fats, oils, fatty acids, and fatty acid esters are used as the additive, although the use of other additives in this embodiment is also envisioned.

According to another embodiment, the feedstock mixture can be prepared as above, but after heating and optionally holding at the first temperature, the feedstock mixture can be granulated, without heating, at lower temperatures using low cost equipment, for instance, roll compactors, graters, and/or extruder graters. The granulation may be performed on a warm feedstock mixture (e.g., about 100° C. to about 200° C.) or a cooled mixture (e.g., less than about 100° C.). The feedstock mixture can then be fed into a furnace or other reaction vessel to be heated to the activation temperature. Exemplary furnaces can include, but are not limited to, fluid bed reactors, rotary kilns, disq furnaces, and belt furnaces, all of which operate at a relatively low cost. This embodiment may be suitable, for example, in the case when fats, oils, fatty acids, and fatty acid esters are used as the additive, although the use of other additives in this embodiment is envisioned.

In a third embodiment, the feedstock mixture may be prepared as above, without the steps of heating to and holding at a first temperature, and without the additional step of granulating the feedstock mixture. The feedstock mixture is not compacted or otherwise pelletized before heating to the activation temperature. This embodiment may be suitable, for example, in the case when the additive does not react in a saponification reaction with the activating agent, e.g., when polyols, cellulose ethers, and silicone oils are used as the additive, although the use of other additives in this embodiment is also envisioned.

In further embodiments, when the optional steps of pre-heating, heating to and holding at a first temperature, grinding, milling, and/or granulating the feedstock mixture with or without heat are omitted, the feedstock mixture may be heated to the activation temperature in a single step. For example, the carbon feedstock, additive, and activating agent may be mixed together and the mixture may then be placed in a crucible or other suitable reaction vessel and heated to the activation temperature. The heating process may be an activation thermal cycle, for instance, a stepwise heating cycle, which can be adjusted, for example, to maximize time spent at any given temperature. By way of non-limiting example, the thermal cycle may provide for a slower heating ramp rate up to the first temperature and then a faster heating ramp rate up to the activation temperature. In other embodiments, a steady heating ramp rate may be employed. According to various embodiments, the heating ramp rate may be steady or variable and may range, for example, from about 50° C./hr to about 300° C./hr, such as from about 100° C./hr to about 250° C./hr, or from about 150° C./hr to about 200° C./hr, including all ranges and subranges therebetween. In the case of an additive that reacts with the activating agent, the reaction can take place during the heating thermal cycle as the feedstock mixture is heated up to the activation temperature.

According to further embodiments, it is possible to charge the feedstock mixture directly into a furnace capable of agitating the mixture, such as a disq furnace, multiple hearth furnace, or a stirred pit/crucible type furnace. In such embodiments, it may be possible to reduce fluxing and foaming while also achieving a granular feedstock in situ as the mixture is heated up to the activation temperature.

The reaction vessels used to mix and/or heat the feedstock mixture may be chosen, for example, from fluid bed reactors, rotary kiln reactors, tunnel kiln reactors, crucibles, microwave reaction chambers, or any other reaction vessel suitable for mixing and/or heating and/or maintaining the feedstock at the desired temperature for the desired period of time. Such vessels can operate in batch, continuous, or semi-continuous modes. In at least one embodiment, the reaction vessel operates in continuous mode, which may provide certain cost and/or production advantages. Because the feedstock mixture includes at least one additive, it is believed that the potential for agglomeration and/or foaming can be significantly decreased, thereby impacting material flowability and/or throughput to a much smaller degree versus other conventional processes.

Microwave heating can also be employed to heat the reaction vessels. A microwave generator can produce microwaves having a wavelength from 1 mm to 1 m (frequencies ranging from 300 MHz to 300 GHz), though particular example microwave frequencies used to form activated carbon include 915 MHz, 2.45 GHz, and microwave frequencies within the C-band (4-8 GHz). Within a microwave reaction chamber, microwave energy can be used to heat a feedstock mixture to a predetermined temperature via a predetermined thermal profile.

Batch processing can also be used and may include, for example, loading the feedstock mixture into a crucible that is introduced into a heating chamber, such as a microwave reaction chamber. Suitable crucibles include those that are compatible with microwave processing and resistant to alkali corrosion. Exemplary crucibles can include metallic (e.g., nickel) crucibles, silicon carbide crucibles or silicon carbide-coated crucibles such as silicon carbide-coated mullite. Continuous feed processes, may include, for example, fluid bed, rotary kiln, tunnel kiln, screw-fed, or rotary-fed operations. Carbon material in the form of a feedstock mixture can also be activated in a semi-continuous process where crucibles of the feedstock mixture are conveyed through a microwave reactor during the acts of heating and reacting.

After activation, the activated carbon can optionally be held in a quench tank where it is cooled to a desired temperature. For instance, the activated carbon may be quenched using a water bath or other liquid or gaseous material. An additional benefit to quenching with water or low temperature steam may include potential neutralization of unreacted alkali metals to minimize potential corrosion and/or combustion hazards. A rotary cooling tube or cooling screw may also be used prior to the quench tank.

After activation and quenching, the activated carbon can be optionally ground to a desired particle size and then washed in order to remove residual amounts of carbon, retained chemical activating agents, and any chemical by-products derived from reactions involving the chemical activating agent. As noted above, the activated carbon can be quenched by rinsing with water prior to grinding and/or washing. The acts of quenching and washing can, in some embodiments, be combined.

The activated carbon may be washed and/or filtered in a batch, continuous, or semi-continuous manner and may take place at ambient temperature and pressure. For example, washing may comprise rinsing the activated carbon with water, then rinsing with an acid solution, and finally rinsing again with water. Such a washing process can reduce residual alkali content in the carbon to less than about 200 ppm (0.02 wt %). In certain embodiments, after quenching and/or rinsing, the activated carbon is substantially free of the at least one chemical activating agent, its ions and counterions, and/or its reaction products with the carbon. For instance, in the case of KOH as the chemical activating agent, the activated carbon is substantially free of KOH, K⁺, OH⁻, and K₂CO₃.

Subsequent to rinsing the activated carbon may be further processed by an optional heat treatment step. For instance, the activated carbon may be heated to a temperature less than the activation temperature, such as, for example, less than about 700° C. In certain embodiments, the activated carbon is heat treated at a temperature of less than about 675° C., for instance, less than about 600° C., or less than about 500° C. In certain embodiments, the optional heat treatment step may include gradually heating the activated carbon to less than about 700° C. using a varying heating ramp rate. For example, the ramp rate may range from about 100° C./hr to about 200° C./hr, such as from about 125° C./hr to about 150° C./hr, including all ranges and subranges therebetween. The heating ramp rate may vary during the heat treatment step and the activated carbon may be held for varying periods of time at different intermediate temperatures. The hold times may range, for example, from about 1 hour to about 4 hours, for example, from about 2 hours to about 3 hours, including all ranges and subranges therebetween. The intermediate temperatures may range, for instance, from about 125° C. to about 500° C., such as from about 150° C. to about 400° C., or from about 200° C. to about 300° C., including all ranges and subranges therebetween.

The optional heat treatment process may be carried out, by way of non-limiting example, in the presence of an inert gas (e.g., N₂) or a forming gas (e.g., N₂/H₂). It is believed that heat treating the activated carbon may serve to reduce oxygen-containing functional groups on the surface of the activated carbon, thereby improving its long term durability, for instance, in an electric double layer capacitor (EDLC).

The activated carbon produced by the methods disclosed herein may have properties, for instance, capacitance, pore volume, and/or pore distribution, comparable to activated carbon produced by prior art methods not employing at least one additive. As used herein, the term “microporous carbon” and variants thereof means an activated carbon having a majority (i.e., greater than 50%) of microscale pores. A microporous, activated carbon material can comprise greater than 50% microporosity (e.g., greater than about 50, 55, 60, 65, 70, 75, 80, 85, 90 or 95% microporosity).

Without wishing to be bound by theory, it is believed that the activating agent intercalates into the carbon and is then removed, leaving behind pores, increasing the surface area and activating the carbonaceous feedstock. The activated carbon can comprise micro-, meso- and/or macroscale porosity. As defined herein, micropores have a pore size of about 20 Å or less and ultra-micropores have a pore size of about 10 Å or less. Mesopores have a pore size ranging from about 20 to about 50 Å. Macropores have a pore size greater than about 50 Å. In one embodiment, the activated carbon comprises a majority of microscale pores.

According to certain embodiments, the activated carbon may have a total porosity of greater than about 0.2 cm³/g (e.g., greater than about 0.2, 0.25, 0.3, 0.35, 0.4, 0.45, 0.5, 0.55, 0.6, 0.65 or 0.7 cm³/g). The portion of the total pore volume resulting from micropores (d₅₀≦20 Å) can be about 90% or greater (e.g., at least about 90, 94, 94, 96, 98 or 99%) and the portion of the total pore volume resulting from micropores (d≦1 nm) can be about 50% or greater (e.g., at least about 50, 55, 60, 65, 70, 75, 80, 85, 90 or 95%).

By way of non-limiting example, the activated carbon produced by the instant methods may have a capacitance of greater than about 70 Farads/cc, such as greater than about 75, 80, 85, 90, or 95 F/cc. In various embodiments, the capacitance of the activated carbon may range from about 70 F/cc to about 100 F/cc.

According to the methods disclosed herein, at least one additive can be included in the feedstock mixture to reduce fluxing and/or foaming during processing.

In certain embodiments, the methods disclosed herein may result in a reduction of foaming of at least about 30%, as compared to prior art methods not employing at least one additive. For instance, the instant methods may result in a reduction of foaming of at least about 40, 50, 60, 70, 80, or 90%. According to various embodiments, the reduction in foaming may range from about 30% to about 90%, or from about 40% to about 80%, or from about 50% to about 70%, including all ranges and subranges therebetween.

The inclusion of the at least one additive in the feedstock mixture may advantageously (a) decrease foaming and thereby increase processing throughput, (b) decrease fluxing and thereby mitigate agglomeration and corrosion. Further, the presently disclosed methods may, in certain embodiments, avoid the need for costly equipment and/or the need for additional processing steps, thereby saving both processing time and expense.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a chemical activating agent” includes examples having two or more such “chemical activating agents” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Other than in the Example, all numerical values expressed herein are to be interpreted as including “about,” whether or not so stated, unless expressly indicated otherwise. It is further understood, however, that each numerical value recited is precisely contemplated as well, regardless of whether it is expressed as “about” that value. Thus, “a temperature greater than 25° C.” and “a temperature greater than about 25° C.” both include embodiments of “a temperature greater than about 25° C.” as well as “a temperature greater than 25° C.”

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a carbon feedstock that comprises a carbonized material include embodiments where a carbon feedstock consists of a carbonized material, and embodiments where a carbon feedstock consists essentially of a carbonized material.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

The following Example is intended to be non-restrictive and illustrative only, with the scope of the invention being defined by the claims.

### EXAMPLE

A carbon feedstock was prepared by carbonizing non-lignocellulosic wheat flour in the presence of nitrogen at about 800° C., using an average ramp rate of about 150° C./hr, and a hold time of about 2 hours. The cooled carbon feedstock was then pulverized, crushed, milled, and sieved to yield a carbonized feedstock powder having an average particle size of about 5 microns +/−0.25 microns. The carbonized feedstock was combined with KOH powder and one of the additives listed in Table I below. In each instance, the weight ratio of KOH to carbon feedstock was approximately 2:1 and the weight ratio of KOH to the additive was approximately 10:1.

The feedstock mixture was charged into a crucible, filling approximately 20% of the crucible volume, and placed in a furnace. The feedstock mixture was heated, in an inert nitrogen atmosphere, to either about 750° C. or about 850° C., using a ramp rate of 150° C./hr. The feedstock mixture was held at the activation temperature for about 2 hours and then cooled. The activated carbon was rinsed with alternating applications of deionized water and hydrochloric acid and subsequently subjected to heat treatment in the presence of a forming gas (1% H₂/N₂). The activated carbon was heated to approximately 125° C. using an average ramp rate of about 150° C./hr, held for approximately 4 hours, then heated to approximately 675° C. using an average ramp rate of about 150° C./hr, held for approximately 2 hours, and then cooled.

Percent foaming was measured by placing a metal strip in the center of the crucible and noting the initial level of the mixture prior to activation and deducting that from how high up the crucible the foam reached after activation. The ratio of this difference to the initial height prior to activation multiplied by 100 was estimated as the percent foaming. A control sample (i.e., a feedstock mixture comprising only carbon feedstock and KOH, without any additive) was also measured for comparison.

The washed and heat treated activated carbon was characterized in terms of capacitance (Farads/cc), density (g/cc), pore volume, and pore size distribution. Capacitance and density were measured by combining the activated carbon with carbon black and a PTFE binder and then forming the mixture into electrodes. The electrode thickness, area, and weight were measured to calculate the density. The electrodes were assembled into button cells to perform the capacitance measurements.

The results of these evaluations are presented in Tables I-III below.

TABLE I
Degree of Foaming, Capacitance, and Density

| | | | | Electrode |
|---|---|---|---|---|
| | Activation | Percent | Capacitance | Density |
| Additive | Temp. (° C.) | Foaming | (F/cc) | (g/cc) |
| Control (none) | 750 | 100.00 | 96.80 | 0.97 |
| Control (none) | 850 | 100.00 | 92.13 | 0.85 |
| Vegetable oil¹ | 750 | 17.65 | 71.30 | 1.10 |
| Vegetable oil¹ | 850 | 11.76 | 92.20 | 0.97 |
| Coconut oil | 750 | 23.53 | 78.24 | 1.08 |
| Coconut oil | 850 | 23.53 | 90.07 | 1.03 |
| Glycerol | 750 | 35.29 | 82.60 | 1.12 |
| Glycerol | 850 | 29.41 | 72.39 | 1.06 |
| XIAMETER ™ | 750 | 41.18 | 97.24 | 0.95 |
| AFE 1410 | | | | |
| XIAMETER ™ | 850 | 41.18 | 90.02 | 0.84 |
| AFE 1410 | | | | |
| ETHOCEL ®-20 | 750 | 64.71 | 97.47 | 0.93 |
| ETHOCEL ®-20 | 850 | 70.59 | 92.60 | 0.88 |

¹Wesson ® vegetable oil

As shown in Table I above, the inclusion of at least one additive served to reduce the degree of foaming as compared to the control samples, while also producing an activated carbon with capacitance comparable to that of the control samples.

TABLE II
Specific Pore Volume

| | Specific Pore Volume (cm³/g) | | | | |
|---|---|---|---|---|---|
| Additive | <10 Å | 10-15 Å | 15-20 Å | 20-50 Å | 50-500 Å |
| Control (none) | 0.448 | 0.108 | 0.026 | 0.008 | 0.004 |
| 750° C. | | | | | |
| Control (none) | 0.560 | 0.164 | 0.082 | 0.033 | 0.002 |
| 850° C. | | | | | |
| Vegetable oil | 0.349 | 0.055 | 0.011 | 0.005 | 0.004 |
| 750° C. | | | | | |
| Vegetable oil | 0.429 | 0.083 | 0.025 | 0.008 | 0.003 |
| 850° C. | | | | | |
| Coconut oil | 0.366 | 0.048 | 0.008 | 0.006 | 0.005 |
| 750° C. | | | | | |
| Coconut oil | 0.412 | 0.068 | 0.018 | 0.006 | 0.005 |
| 850° C. | | | | | |
| Glycerol | 0.385 | 0.073 | 0.010 | 0.007 | 0.005 |
| 750° C. | | | | | |
| Glycerol | 0.362 | 0.038 | 0.006 | 0.003 | 0.006 |
| 850° C. | | | | | |
| XIAMETER ™ | 0.444 | 0.121 | 0.032 | 0.014 | 0.008 |
| AFE 1410 | | | | | |
| 750° C. | | | | | |
| XIAMETER ™ | 0.419 | 0.161 | 0.118 | 0.032 | 0.003 |
| AFE 1410 | | | | | |
| 850° C. | | | | | |
| ETHOCEL ®-20 | 0.487 | 0.113 | 0.033 | 0.013 | 0.006 |
| 750° C. | | | | | |
| ETHOCEL ®-20 | 0.489 | 0.130 | 0.054 | 0.018 | 0.003 |
| 850° C. | | | | | |

TABLE III
Pore Distribution

| | Percentage of Pores | | |
|---|---|---|---|
| | with Specific Pore Size | | |
| | Micropores | Mesopores | Macropores |
| Additive | <20 Å | 20-50 Å | >50 Å |
| Control (none) | 97.88% | 1.36% | 0.75% |
| 750° C. | | | |
| Control (none) | 95.79% | 3.97% | 0.25% |
| 850° C. | | | |
| Vegetable oil | 97.96% | 1.09% | 0.95% |
| 750° C. | | | |
| Vegetable oil | 97.98% | 1.43% | 0.59% |
| 850° C. | | | |
| Coconut oil | 97.50% | 1.40% | 1.10% |
| 750° C. | | | |
| Coconut oil | 97.94% | 1.12% | 0.93% |
| 850° C. | | | |
| Glycerol | 97.64% | 1.40% | 0.96% |
| 750° C. | | | |
| Glycerol | 97.88% | 0.61% | 1.52% |
| 850° C. | | | |
| XIAMETER ™ | 96.46% | 2.21% | 1.34% |
| AFE 1410 | | | |
| 750° C. | | | |
| XIAMETER ™ | 95.21% | 4.35% | 0.44% |
| AFE 1410 | | | |
| 850° C. | | | |
| ETHOCEL ®-20 | 97.00% | 2.02% | 0.97% |
| 750° C. | | | |
| ETHOCEL ®-20 | 96.99% | 2.62% | 0.39% |
| 850° C. | | | |

As demonstrated by Table II, the inventive feedstock mixtures comprising additives yielded activated carbon having a pore size, distribution, and specific volume comparable to those of activated carbon prepared from a prior art feedstock mixture without an additive. Table III further demonstrates that all samples have a similar percentage of micropores, mesopores, and macropores. In particular, all samples appear to have between about 95% and 98% micropores.

The data presented above illustrates that methods according to the disclosure using a feedstock mixture comprising at least one additive are able, among other things, to reduce foaming during processing while still yielding an activated carbon product that is otherwise comparable to the activated carbon obtained using prior art methods.

What is claimed is:

1. A method for forming activated carbon, said method comprising:
providing a feedstock mixture comprising a carbon feedstock, at least one activating agent chosen from alkali metal hydroxides, and at least one additive chosen from fats, oils, fatty acids, and fatty acid esters;
optionally heating the feedstock mixture to a first temperature, and when a step of heating the feedstock mixture to a first temperature is performed, optionally holding the feedstock mixture at the first temperature for a time sufficient to react the at least one activating agent with the at least one additive;
optionally granulating the feedstock mixture;
heating the feedstock mixture to an activation temperature; and
holding the feedstock mixture at the activation temperature for a time sufficient to form activated carbon.

2. The method according to claim 1, wherein the feedstock mixture is formed by mixing the carbon feedstock and the at least one additive, and subsequently adding the at least one activating agent.

3. The method according to claim 1, wherein the feedstock mixture is mixed at a temperature ranging from about 25° C. to about 150° C.

4. The method according to claim 1, further comprising forming the carbon feedstock by carbonizing at least one carbonaceous material in an inert atmosphere at a temperature ranging from about 500° C. to 950° C. and optionally crushing, pulverizing, and/or milling the carbon feedstock to form a carbonized powder.

5. The method according to claim 1, wherein the at least one activating agent is chosen from KOH, NaOH, LiOH, and mixtures thereof.

6. The method according to claim 1, wherein the at least one additive is chosen from animal fats, vegetable oils, and mixtures thereof.

7. The method according to claim 6, wherein the at least one additive is chosen from tallow, fish oil, whale oil, liver oil, butter, coconut oil, palm kernel oil, palm oil, nutmeg oil, olive oil, soybean oil, sesame oil, safflower oil, linseed oil, castor oil, canola oil, and mixtures thereof.

8. The method according to claim 1, wherein the fatty acids are chosen from saturated and unsaturated fatty acids comprising from about 2 to about 30 carbon atoms, and mixtures thereof.

9. The method according to claim 8, wherein the fatty acids are chosen from acetic acid, propanoic acid, butyric acid, caproic acid, caprylic acid, capric acid, lauric acid, myristic acid, palmitic acid, palmitoleic acid, stearic acid, oleic acid, linoleic acid, linoleric acid, arachidonic acid, behenic acid, and mixtures thereof.

10. The method according to claim 1, wherein the molar ratio of the at least one activating agent to the at least one additive in the feedstock mixture is greater than or equal to about 1:1.

11. The method according to claim 10, wherein the molar ratio of the at least one activating agent to the at least one additive in the feedstock mixture is greater than or equal to about 3:1.

12. The method according to claim 1, wherein the weight ratio of the at least one activating agent to the at least one additive in the feedstock mixture ranges from about 5:1 to about 30:1.

13. The method according to claim 1, wherein the feedstock mixture is wet or dry.

14. The method according to claim 1, wherein the first temperature ranges from about 25° C. to about 250° C. and the feedstock mixture is optionally held at the first temperature for a time period ranging from about 1 minute to about 120 minutes.

15. The method according to claim 1, wherein the feedstock mixture is optionally granulated at a temperature less than or equal to about 500° C.

16. The method according to claim 1, wherein the activation temperature ranges from about 700° C. to about 900° C. and the feedstock mixture is held at the activation temperature for a time ranging from about 5 minutes to about 6 hours.

17. The method according to claim 1, further comprising a step of cooling, collecting, rinsing, and/or heat treating the activated carbon.

18. A method for forming activated carbon, said method comprising:
providing a feedstock mixture comprising a carbon feedstock, at least one activating agent chosen from alkali metal hydroxides, and at least one additive chosen from polyols, cellulose ethers, and ionic and non-ionic silicone oils;
optionally grinding and/or milling the feedstock mixture;
heating the feedstock mixture to an activation temperature; and
holding the feedstock mixture at the activation temperature for a time sufficient to form activated carbon,
wherein the feedstock mixture is in particulate form.

19. The method according to claim 18, wherein the polyols are chosen from glycerol, polyether polyols, and polyester polyols.

20. The method according to claim 18, wherein the cellulose ethers are chosen from methylcellulose, hydroxymethylcellulose, carboxymethylcellulose, ethylcellulose, hydroxyethylcellulose, carboxyethylcellulose, hydroxyypropylcellulose, derivatives thereof, and mixtures thereof.
